(19) United States
(12) Patent Application Publication
(10) Pub. No.: US 2020/0119622 A1
(43) Pub. Date: Apr. 16, 2020

(54) METHOD FOR CONTROLLING THE AMBIENT TEMPERATURE VAPORIZATION OF CARBON DIOXIDE

(71) Applicant: Airgas, Inc., Radnor, PA (US)

(72) Inventors: Mark Joseph DOORE, Perrysburg, OH (US); Gregory CANIGLIA, Brecksville, OH (US); James A. STEWART, Perrysburg, OH (US); Eric L. COLLINGE, Stow, OH (US); Christopher G. WILLIAMS, Brunswick, OH (US); Andrew D. SLAUGH, El Dorado Hills, CA (US)

(21) Appl. No.: 16/160,064

(22) Filed: Oct. 15, 2018

(51) Int. Cl. H02K 9/24; B08B 5/00

(52) U.S. Cl. CPC H02K 9/24; B08B 2220/01; B08B 5/00

(57) ABSTRACT

A method for controlling the ambient temperature vaporization of carbon dioxide, including introducing a liquid carbon dioxide stream at a supply pressure into a pressure reduction valve, thereby producing a carbon dioxide stream at a delivery pressure is provided. The method includes introducing the carbon dioxide stream at the delivery pressure into a heat exchange device, thereby exchanging heat between a stream of ambient temperature air and the liquid carbon dioxide stream, thereby producing a vaporized carbon dioxide stream at the delivery pressure, and introducing the vaporized carbon dioxide stream at the delivery pressure into a backpressure regulator, thereby maintaining the vaporized carbon dioxide stream above a minimum delivery pressure.

### BACKGROUND

Hydrogen gas is frequently used for generator cooling in gas-fired turbine generators. These generators require periodic service, which involved access into the generator. Prior to entry into the generator, the hydrogen must be purged. Carbon dioxide is used as an intermediate gas to purge the hydrogen. This prevents direct contact between the hydrogen and air to prevent a combustible mixture of hydrogen and oxygen. Once hydrogen is purged to safe levels, the carbon dioxide is then purged using air. The air provides a safe working environment once oxygen and carbon dioxide meet required levels. When service work is complete, the process is reversed. Carbon dioxide is used to purge the air and then the carbon dioxide is purged with hydrogen.

Bulk liquid carbon dioxide systems with electric heaters are often used as the CO2 source when the generator size is large or the power plant has multiple generators. The use of electric heaters in these systems makes operation impossible during electrical black out conditions where no internal electricity is being produced, and where no external electricity is available. Smaller facilities will use high-pressure CO2 cylinders utilizing gas phase withdrawal from the cylinders. In the current state-of-the-art, these systems are susceptible to dry ice blockage or very slow purge times.

Smaller facilities must utilize high-pressure carbon dioxide gas cylinders as their supply source. Purging hydrogen with carbon dioxide from cylinders is currently a manual process that is very labor intensive and slow. Due to the nature of carbon dioxide, withdrawal from the gas phase of high-pressure cylinders often results in freezing of lines, valves and regulators; collapse of the head pressure; and even solidification of the liquid in the cylinders to dry ice. Additionally, the cold liquid or gas coming from the cylinders presents a safety risk for personnel and for supply systems. Some carbon dioxide purge gas systems have been fitted in an ad hoc manner with heated regulators and/or electric heaters, but they are still manual, labor intensive and their operation is frequently interrupted or slowed down for cylinder exchanges.

Cylinder freezing and loss of head pressure slows down or stops the purging process. This creates an extremely unsafe condition in that the operator may think the cylinder contents have been delivered to the generator when, in fact, they have not. This false line of thinking has led to fatalities, where operators think they have adequately purged the generator but have not.

### SUMMARY

A method for controlling the ambient temperature vaporization of carbon dioxide, including introducing a liquid carbon dioxide stream at a supply pressure into a pressure reduction valve, thereby producing a carbon dioxide stream at a delivery pressure, introducing the carbon dioxide stream at the delivery pressure into a heat exchange device, thereby exchanging heat between a stream of ambient temperature air and the liquid carbon dioxide stream, thereby producing a vaporized carbon dioxide stream at the delivery pressure, and introducing the vaporized carbon dioxide stream at the delivery pressure into a backpressure regulator, thereby maintaining the vaporized carbon dioxide stream above a minimum delivery pressure.

### BRIEF DESCRIPTION OF THE DRAWINGS

For a further understanding of the nature and objects for the present invention, reference should be made to the following detailed description, taken in conjunction with the accompanying drawings, in which like elements are given the same or analogous reference numbers and wherein:

FIG. 1 is a schematic representation of a phase diagram for carbon dioxide.

FIG. 2 is a schematic representation of a controlled ambient temperature vaporization system in accordance with one embodiment of the current invention.

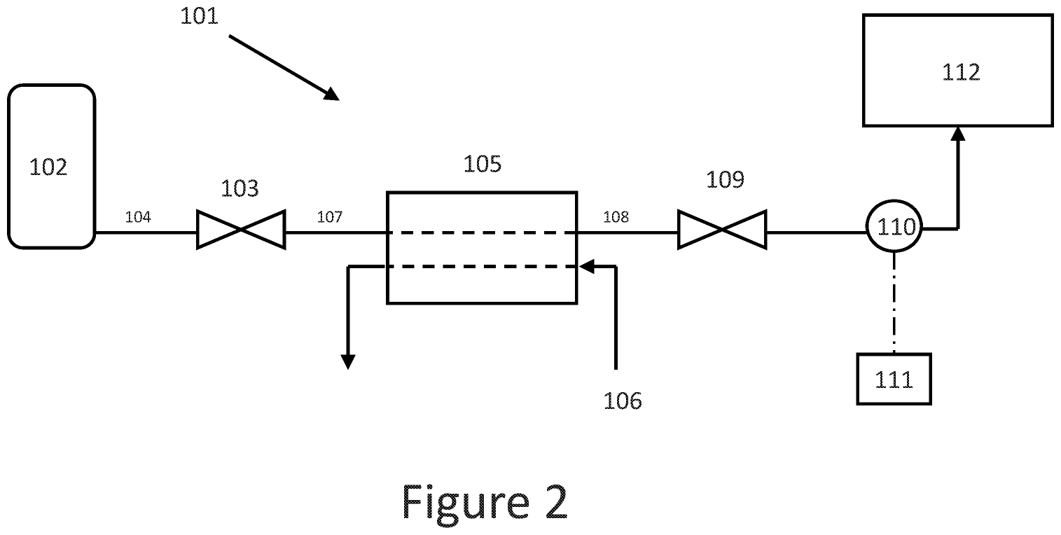

### DESCRIPTION OF PREFERRED EMBODIMENTS

### Element Numbers

101=A controlled ambient temperature vaporization system

102=A pressurized liquid carbon dioxide source (at the supply pressure)

103=A pressure reduction valve

104=A liquid carbon dioxide stream at the supply pressure

105=A heat exchange device

106=An ambient temperature air stream

107=A carbon dioxide stream at the delivery pressure

108=A vaporized carbon dioxide stream at the delivery pressure

109=A backpressure regulator

110=A flowrate totalizer

111=An uninterruptible power supply

112=A generator

### Definitions

As used herein, the term “ambient temperature air” is defined as the temperature of the surrounding air. No additional heat is added to the “ambient temperature air” prior to introduction into the ambient temperature heat exchange device.

As used herein, the term “ambient temperature air stream” is defined as a flow of ambient temperature air that is introduced into the heat exchange device by means of either natural convection or by forced circulation.

As used herein, the term “triple point” is defined as the temperature and pressure at which a fluid is at equilibrium in gas, liquid and solid phase. For carbon dioxide, the triple point is −70 F and 75 psia.

As used herein, the term “deposition pressure” is defined as the pressure at which carbon dioxide changes from the gas phase to the solid phase.

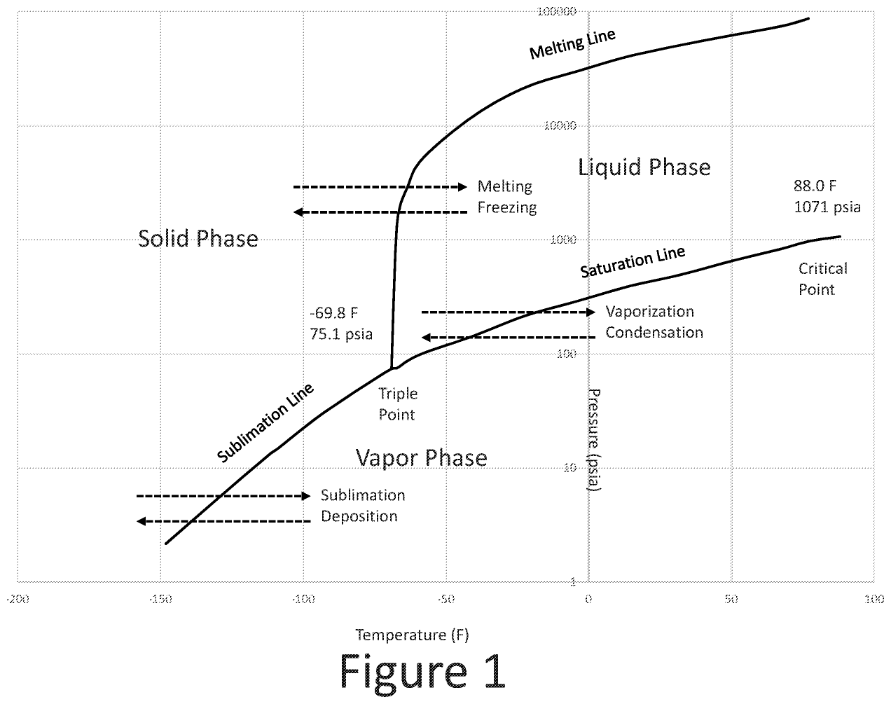

Carbon dioxide is a molecule that has characteristics that have been extensively analyzed. A distinctive quality exhibited by carbon dioxide is that of sublimation and deposition. As shown in FIG. 1, at temperatures below about −70 F and at pressures below about 75 psia, solid phase carbon dioxide passes from the vapor phase directly into the solid phase, without ever entering a liquid phase. Thus, if at any point in the system, there is either sufficient heat removal or pressure reduction (or both) in a vapor stream under these conditions solid carbon dioxide will form. In the present system, the presence of solid carbon dioxide is undesirable. However, above the so-called “triple point”, removing heat or reducing pressure (or both) in this stream will simply condense the carbon dioxide into a liquid phase, which can then be moved through the system as desired. Likewise, should the temperature increase in a liquid phase carbon dioxide stream above the triple point, vapor phase carbon dioxide will form.

Turning to FIG. 1, a controlled ambient temperature vaporization system 101 is provided. This system includes a source of liquid carbon dioxide 102 at a supply pressure P_{S}. The supply pressure P_{S} may be greater than 750 psia, preferably greater than 800 psia, more preferably between 830 psia and 835 psia. The supply pressure P_{S} may be above the critical point (88 F, 1071 psia), preferably about 1800 psi.

The system also includes a pressure reduction valve 103, designed to reduce the liquid carbon dioxide 104 from the supply pressure Pₛ to a delivery pressure P_{D}. The delivery pressure may be less than 150 psia, preferably less than or equal to 125 psia.

Above the critical point, the carbon dioxide would be neither liquid nor vapor, but supercritical fluid. As the supercritical fluid passes through pressure reduction valve 103, the carbon dioxide will drop below the critical pressure to the delivery pressure P_{D}.

Should carbon dioxide source 102 emptied of liquid, depending on the remaining pressure, as much as one-half of the fill weight will remain in vapor form. From such a source (for example a dip tube cylinder or siphon tube cylinder), the remaining vapor phase carbon dioxide may still be removed, as the subsequent pressure reduction to the delivery pressure P_{D} will reduce the vapor pressure and still require heating prior to delivery to the user. Therefore, the present system may function with carbon dioxide delivery in the form of supercritical, liquid, or vapor phase. The preferred delivery phase is liquid.

The system also includes a heat exchange device 105, designed to exchange heat between a stream of ambient temperature air 106 and the carbon dioxide at delivery pressure 107, thereby producing a vaporized carbon dioxide stream 108. No additional heating source is used to provide energy to heat exchange device 105 other than ambient temperature air. Ambient temperature air stream 106 may be introduced into heat exchange device 105 by means of natural convection, or by means of a forced circulation, such as by means of a blower or fan.

As a non-limiting, illustrative example, if one presumes a modest 20 F approach temperature for the heat exchanger, given that the triple point temperature for carbon dioxide is −70 F, if the ambient temperature is greater than −50 F, there will be sufficient ambient heat energy to avoid deposition at pressures greater than the minimum delivery pressure P_{DM}, discussed below. This is not to suggest that such a system will be operating at such low ambient temperatures, but simply to illustrate the adequacy of the available ambient heat. Hence, no additional heating source is used or required to provide energy to heat exchange device 105 other than ambient temperature air.

The system includes a backpressure regulator 109, configured to maintain the vaporized carbon dioxide 108 above a minimum delivery pressure P_{DM}. The minimum delivery pressure P_{DM} may be above the triple point temperature for carbon dioxide, preferably greater than 75 psia, more preferably greater than 100 psia. As these are greater than any deposition pressure, this reduces or eliminates the possibility of solid carbon dioxide snow forming in this stream.

The backpressure regulator will maintain the system pressure at 100 and keep it above 75 psia at the lowest. Should the system pressure drop below 100 psia, back pressure regulator 109 will begin to close, in order to maintain the system above the minimum delivery pressure, which shall be not less than 75 psia. It is the unique combination of pressure reduction valve 103 and backpressure regulator 109 that provides precise control of the pressure within ambient temperature vaporizer 105 and ensures that no dry ice is formed.

In the system, the source of liquid carbon dioxide 102 may be one or more vessels selected from the group consisting of a dip tube cylinder, a pressurized liquid cylinder, a microbulk cylinder, and/or a bulk cylinder. It should be noted that regardless of the source of the container, it is liquid carbon dioxide that is withdrawn from the container in all cases

The system may also include a flowrate totalizer 110 that is configured to provide a running total of the carbon dioxide flowrate 108 during a predetermined time period. The flowrate totalizer 110 may be powered by a local uninterruptible power source 111. The system requires no external power supply.

It is preferred to be able to purge out the hydrogen without the use of electricity. A power plant will purge for either planned or unplanned (emergency) outages. It is possible that a power plant can have a black out condition due to an unplanned outage where they do not have power.

It is important to be able to monitor the amount of CO2 delivered to the generator. The addition of the flowmeter is done so that an operator can know if an adequate amount of CO2 was delivered to the process. The amount typically delivered is 2× the generator internal volume.

While power plants have fewer issues with bulk systems, there are still issues with the fact that they rely on electricity in order to deliver vaporized gas to the generator. Further, there is a benefit to the flowmeter in this application as well.

Also provided is a method for controlling the ambient temperature vaporization of carbon dioxide utilizing the above-discussed system.

It will be understood that many additional changes in the details, materials, steps and arrangement of parts, which have been herein described in order to explain the nature of the invention, may be made by those skilled in the art within the principle and scope of the invention as expressed in the appended claims. Thus, the present invention is not intended to be limited to the specific embodiments in the examples given above.

What is claimed is:

1. A method for controlling the ambient temperature vaporization of carbon dioxide, comprising:
introducing a liquid carbon dioxide stream at a supply pressure into a pressure reduction valve, thereby producing a carbon dioxide stream at a delivery pressure,
introducing the carbon dioxide stream at the delivery pressure into a heat exchange device, thereby exchanging heat between a stream of ambient temperature air and the liquid carbon dioxide stream, thereby producing a vaporized carbon dioxide stream at the delivery pressure,
introducing the vaporized carbon dioxide stream at the delivery pressure into a backpressure regulator, thereby maintaining the vaporized carbon dioxide stream above a minimum delivery pressure, and
a flowrate totalizer, thereby providing a running total of the carbon dioxide during a predetermined time period,
wherein no external power supply is required.

2. The method of claim 1, further comprising a source of liquid carbon dioxide, comprising one or more vessels selected from the group consisting of a dip tube cylinder, a pressurized liquid cylinder, a microbulk cylinder, a bulk cylinder.

3. The method of claim 1, wherein the minimum delivery pressure is greater than deposition pressure.

4. The method of claim 1, wherein the vaporized carbon dioxide stream is introduced into a generator as a purge gas.

5. The method of claim 1, wherein the flowrate totalizer is powered by a local uninterruptible power source.
